(19) United States
(12) Patent Application Publication
(10) Pub. No.: US 2015/0338329 A1
(43) Pub. Date: Nov. 26, 2015

(54) BULK MODULUS MEASUREMENT AND FLUID DEGRADATION ANALYSIS

(71) Applicant: Caterpillar Inc., Peoria, IL (US)

(72) Inventors: EMILY A. MORRIS, Peoria, IL (US); JEFFREY L. KUEHN, Germantown Hills, IL (US); MARTIN J. MORRIS, West Peoria, IL (US); MARIO MEDINA, Chicago, IL (US); EMERY P. HALVERSON, Peoria, IL (US); TYLER R. PORT, Peoria, IL (US); CHRISTOPHER R. CHURCHILL, Albany, IL (US); JOHN REVALLO, V, Peoria, IL (US); CHRISTOPHER L. ADOLPHSON, Peoria, IL (US)

(73) Assignee: Caterpillar Inc., Peoria, IL (US)

(21) Appl. No.: 14/813,147

(22) Filed: Jul. 30, 2015

(51) Int. Cl. G01N 7/00

(52) U.S. Cl. CPC G01N 7/00

(57) ABSTRACT

An apparatus and method to analyze fluid degradation in a closed system is disclosed. The method includes collection of a sample fluid from the closed system. The sample fluid collected is maintained at a sample fluid pressure, which is substantially equivalent to a pressure of the closed system. Thereafter, a change of a volume of the sample fluid is caused, which generates a change in the sample fluid pressure. A series of sample fluid pressures and volumes of the sample fluid are taken. Next, a bulk modulus of the sample fluid is determined. The bulk modulus of the sample fluid is compared with a baseline bulk modulus. Lastly, the method involves generation of a communication when the bulk modulus of the sample fluid breaches a tolerance.

### TECHNICAL FIELD

The present disclosure relates generally to an apparatus and a method to analyze degradation of a fluid in a hydraulic circuit. More specifically, the present disclosure relates to measurement of a bulk modulus and a compressibility of the fluid that may be detrimental to effective operation of the hydraulic circuit.

### BACKGROUND

Many work machines, such as earthworking machines, or the like, include hydraulic circuits to run motors and cylinders, for example. These hydraulic circuits typically include components, such as pumps and actuators, which have moving parts and sealing systems that may wear out and eventually fail. One reason for such failures is that the hydraulic fluids within these hydraulic circuits may compress and decompress due to pressure changes. An abrupt pressure change, for example, may cause the formation and subsequent implosion of gaseous bubbles within the hydraulic fluid. As a result, pressure waves are created that may lead to an increased rate of wear and cyclic fatigue failure of the components. In addition, a pump or a hydraulic component may sustain conditions such as cavitation (or the formation of cavities), which may harm the hydraulic circuit's efficiency.

It is well known in the art to initiate preventive maintenance strategies and a fluid change to prevent such failures. However, without accurate determination of the fluid's characteristics, a machine's downtime may be inappropriately notified. For example, such notification may be generated well before the occurrence of an actual downtime. As a result, a component of the hydraulic circuit may have to be unduly replaced or repaired well before its warranted operational life. Conversely, an inability to timely determine an initial stage failure of components may lead to uncertainty and an increased possibility of a future catastrophic failure. Therefore, it has remained a challenge to determine an opportune time to schedule preventive maintenance strategies, given the difficulty in assessing a component's failure. Consequentially, losses in productivity may occur due to ineffectively scheduled maintenance programs.

U.S. Pat. No. 2,880,611 A relates to an apparatus for the measurement of bulk modulus in a hydraulic circuit. Although the '611 reference discusses the computation of a compressibility curve, the associated apparatus is integrated into a conduit from where it remains difficult to utilize the apparatus in multiple hydraulic assemblies. Moreover, room remains to further simplify a power system that samples and generates variation of pressure versus volume of a hydraulic fluid. This is because the apparatus of the '611 reference is dependent upon external power, such as hydraulic power, to induce an associated pressure.

Accordingly, the system and method of the present disclosure solves one or more problems set forth above and other problems in the art.

### SUMMARY OF THE INVENTION

Various aspects of the present disclosure illustrate a method to analyze fluid degradation in a closed system. The method includes a collection of a sample fluid from the closed system. The sample fluid is maintained at a sample fluid pressure, which is substantially equivalent to a pressure of the closed system. Thereafter, a change of a volume of the sample fluid is effectuated to generate a change in the sample fluid pressure. Thereafter, a series of sample fluid pressure and volume of the sample fluid is taken. A bulk modulus of the sample fluid is established. Subsequently, a comparison between the bulk modulus of the sample fluid to a baseline bulk modulus is conducted. If the bulk modulus of the sample fluid breaches a tolerance, the method ends with the generation of a corresponding communication.

### BRIEF DESCRIPTION OF THE DRAWINGS

FIG. 1 is a partial view of a power system, illustrated with an exemplary bulk modulus apparatus in a potential assembly position relative to the power system, in accordance with the concepts of the present disclosure;

FIG. 2 is an enlarged perspective view of the bulk modulus apparatus of FIG. 1;

FIG. 3 is an exploded view of the bulk modulus apparatus of FIG. 1;

FIG. 4 is a schematic view of the bulk modulus apparatus of FIG. 1, in accordance with the concepts of the present disclosure; and

FIG. 5 is a flowchart of an exemplary method of operation of the bulk modulus apparatus, in accordance with the concepts of the present disclosure.

### DETAILED DESCRIPTION

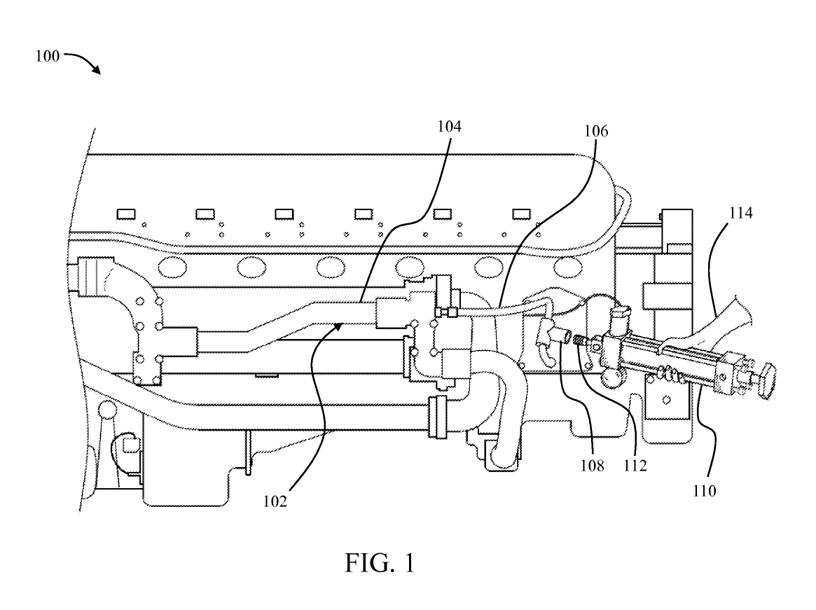

Referring to FIG. 1, there is shown an exemplary power system 100. The power system 100 is partially shown for clarity and ease in depicting the aspects of the present disclosure. Although not limited, the power system 100 may be an engine, such as a spark-ignition engine or a compression ignition engine, which may be applied in construction machines, such as track-type tractors, hydraulic excavators, wheel loaders, motor graders, and large mining trucks. However, it will be appreciated that aspects of the present disclosure are focused to a hydraulic circuit 102, which is incorporated within the power system 100. Therefore, it may be well suited for one to apply and extend an applicability of the present disclosure to hydraulic circuits that operate elsewhere. For example, hydraulic circuits in transmission units, work implements, fuel systems, drivetrains, and the like, may suitably benefit from one or more aspects disclosed herein. An extension of the application to domestic and commercial application may also be contemplated.

The hydraulic circuit 102 may be a closed system, incorporated within the power system 100. The hydraulic circuit 102 may be utilized for execution of one or more functions associated with the power system 100. As an example, the hydraulic circuit 102 may be configured to actuate a gas exchange valve of the power system 100. In another example, the hydraulic circuit 102 may be operably connected to the power system 100 and may be used to run an associated fan drive unit (not shown) of the power system 100. In some embodiments, the hydraulic circuit 102 may use the same oil as the power system 100's lubricating system, for the performance of one or more applications.

The hydraulic circuit 102 is inclusive of a conduit 104, which facilitates passage of a hydraulic fluid from one portion of the hydraulic circuit 102 to another. The conduit 104 is connected to a sample flow line 106, which may be interchangeably referred to as a test line 106. In an embodiment, the test line 106 may be a closed loop bypass connection within the hydraulic circuit 102 that facilitates passage of a portion of the hydraulic fluid, and returns that portion to the hydraulic circuit 102. The test line 106 may be subject to a passage of an amount of hydraulic fluid during an operation of the hydraulic circuit 102. The test line 106 may be conducted within an existing line of the hydraulic circuit 102. However, it is envisioned that the test line 106 may differ from other passages, and is retrofitted to the hydraulic circuit 102.

The test line 106 includes a quick-disconnect coupler 108 that facilitates a temporary fluid connection between the hydraulic circuit 102 and a working hydraulic accessory, such as a bulk modulus measurement apparatus 110 (or simply, a bulk modulus apparatus 110). The quick-disconnect coupler 108 is of a type which prevents the hydraulic fluid from flowing out of the test line 106 when the quick-disconnect coupler 108 is uncoupled. The quick-disconnect coupler 108 may be a widely available standardized coupler unit adapted for relatively quick connections and disconnections with a counter-mating coupler, such as a counter-mating coupler 112 of the bulk modulus apparatus 110. As an example, the quick-disconnect coupler 108 may be a female coupler unit, into which a male counter-mating coupler 112 is threadably fitted or press-fitted, for assembly.

As illustrated in FIG. 1, the bulk modulus apparatus 110 is in an exemplary assembly position relative to the hydraulic circuit 102. The bulk modulus apparatus 110 is generally portable and is configured to be manually held by an operator 114 114, as shown. As the bulk modulus apparatus 110 is provided with a counter-mating coupler 112, a connection between the test line 106 and the bulk modulus apparatus 110 is attainable, which, in turn, allows the bulk modulus apparatus 110 to retrieve a sample of the hydraulic fluid that passes through the test line 106.

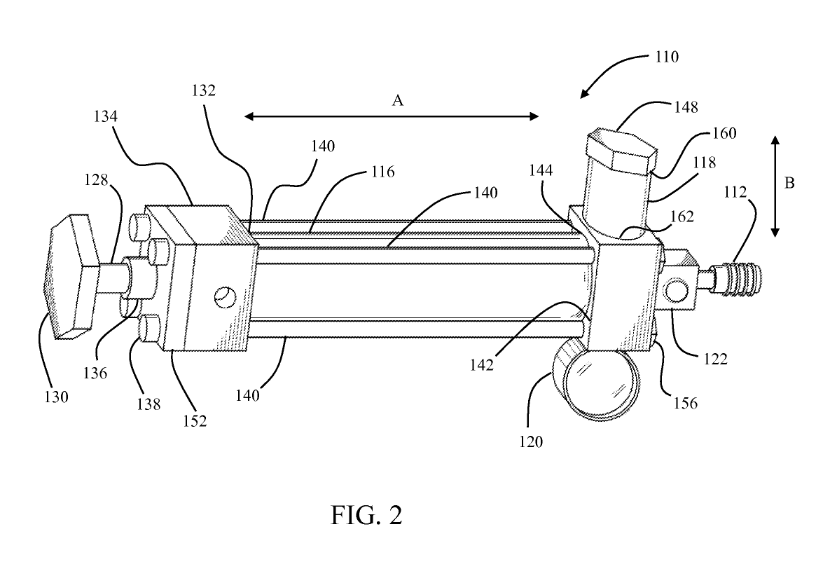

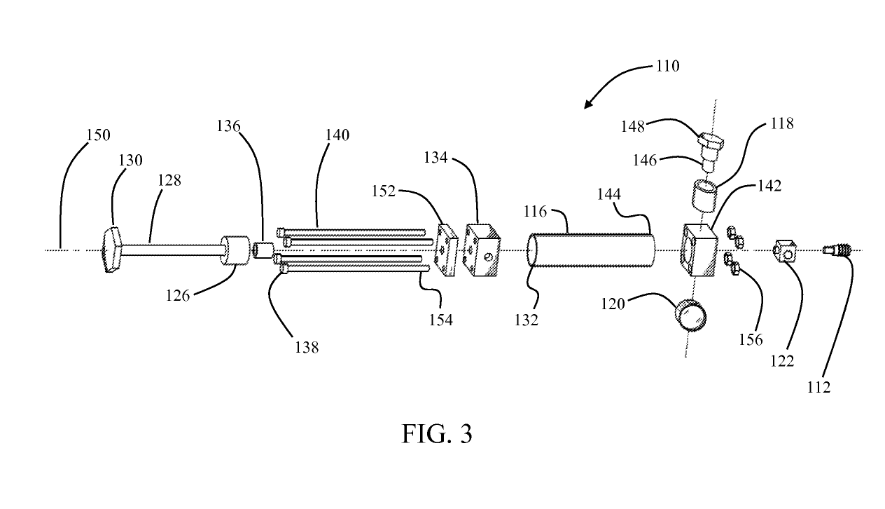

Referring to FIGS. 2 and 3, the bulk modulus apparatus 110 is shown in greater detail. The bulk modulus apparatus 110 includes a primary cylinder 116, a secondary cylinder 118, a pressure gauge 120, and an open/close ball valve 122.

The primary cylinder 116 and the secondary cylinder 118 (or simply cylinders 116 and 118) are generally longitudinal, hollow members capable of accommodating, at least temporarily, a fluid extracted from the test line 106 of a charged hydraulic circuit 102. The cylinders 116 and 118 are generally positioned at right angles to each other, although this configuration is not limited and a plurality of angular placement between the primary cylinder 116 and the secondary cylinder 118 is envisioned. The primary cylinder 116 is larger in dimension in relation to the secondary cylinder 118. Accordingly, the primary cylinder 116 is adapted to hold a higher quantity of the hydraulic fluid as compared to the secondary cylinder 118.

The primary cylinder 116 is generally barrel shaped and has a substantially circular cross-sectional profile. The primary cylinder 116 includes a primary piston 126 (FIG. 3), a piston plunger 128, and a primary hex head 130. The primary piston 126 is configured to move back and forth along an elongation, A, (or a longitudinal axis 150) of the primary cylinder 116, during applications. The primary piston 126 (FIG. 3) is generally positioned into a depth of the primary cylinder 116 so as to vary a holding volume of the primary cylinder 116. This variation is possible by manipulating the primary hex head 130, which is accessible to an operator 114 deployed outside of the primary cylinder 116. Further, the piston plunger 128 is connected between the primary piston 126 (FIG. 3) and the primary hex head 130, and, in that way, the piston plunger 128 allows the primary piston 126 to be varied in depth upon a manipulation by the primary hex head 130.

The primary cylinder 116 is generally closed at its two ends 132 and 144. The primary cylinder 116 includes a cylinder head 134 and an end cap 152 positioned at one end 132, and a cylinder base 142 at the other end 144 (FIG. 2). These facilitate sealing of the primary cylinder 116 at the ends 132 and 144 (FIG. 2). Moreover, the primary cylinder 116 includes tie rods 140, which are exemplified in the present disclosure as being four in number. The tie rods 140 are assembled along the primary cylinder 116′s outer structure to affirm a tightened connection between the cylinder head 134 and the end cap 152 at the one end 132 (FIG. 2), and the cylinder base 142, at the other end 144 (FIG. 2). In this manner, the primary cylinder 116 is positively sealed at both ends 132 and 144 (FIG. 2). As is customary, tie rods 140 may generally be ‘long bolts’ that have bolt heads 138 at one end 132 and threads 154 (FIG. 3) at the other end 144. The bolt heads 138 of the tie rods 140 engages the end cap 152, while the threads engages the cylinder base 142 and are secured by hex nuts 156, as is customary. Further, the end cap 152 includes a collar 136 positioned at an interface between the piston plunger 128 and the end cap 152. The collar 136 provides the piston plunger 128 with guidance to effectively accomplish the motion associated with the back and forth movement of the primary piston 126.

The secondary cylinder 118 is positioned at substantial right angles relative to the primary cylinder 116, as already noted. However, this configuration is purely exemplary in nature. Therefore, the secondary cylinder 118 may be positioned at an incline to the primary cylinder 116 so as to make the bulk modulus apparatus 110 more compact, for example. In structure, the secondary cylinder 118 may be similar in shape and function to the primary cylinder 116. However, the secondary cylinder 118 is much smaller is size than the primary cylinder 116, as noted above. At an outer end 160 (FIG. 2) of the secondary cylinder 118, there is included a secondary hex head 148, which is adapted to linearly manipulate a secondary piston 146 (FIG. 3) positioned generally within the confines of the secondary cylinder 118. Therefore, as with the primary piston 126, the secondary piston 146 may be moveable across an elongation, B, of the secondary cylinder 118, as well. At the opposite end 162 of the secondary cylinder 118, the secondary cylinder 118 merges with the primary cylinder 116 and is in fluid communication with the primary cylinder 116. In an embodiment, it may be beneficial to have both the cylinders 116 and 118 formed as an integrated unit.

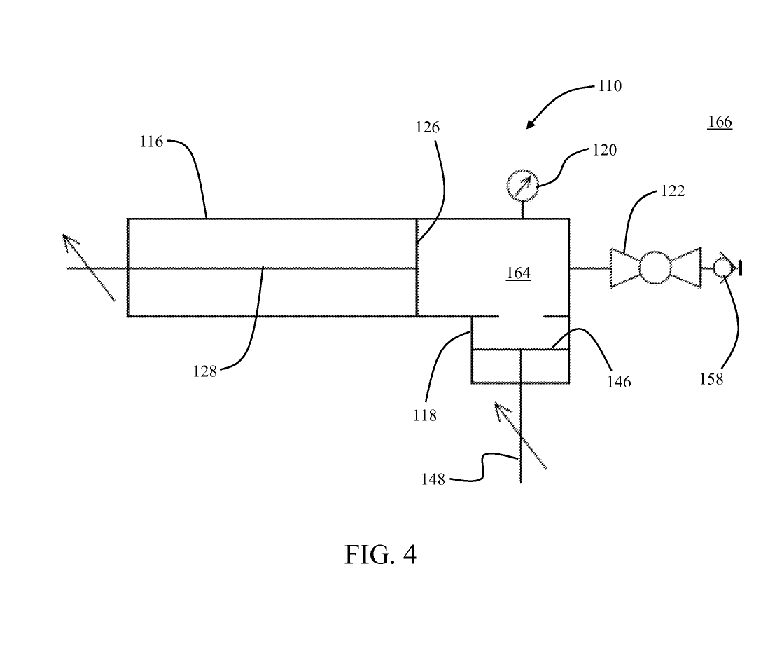

Referring to FIGS, 2, 3, and 4, the cylinder base 142 (FIGS. 2 and 3) is generally block-shaped, and forms a connection interface between the primary cylinder 116 and the secondary cylinder 118. In the depicted embodiment, the secondary cylinder 118 is mounted to this block-shaped cylinder base 142 so as to be fluidly connected with the primary cylinder 116. In this manner, both the cylinders 116 and 118 define a common volume or a chamber 164 (FIG. 4). Further, by manipulation of the primary hex head 130 and the secondary hex head 148, both cylinders 116 and 118 may receive a sample hydraulic fluid (or simply sample fluid) and affect a volume of the cylinders 116 and 118. The primary cylinder 116 is configured to vary volume of a housed fluid in relatively larger degree, while the secondary cylinder 118 is configured to affect volume of the housed fluid in a relatively smaller or a finer degree.

The chamber 164 (FIG. 4) houses a volume of the sample fluid extracted from the charged hydraulic circuit 102, during applications. The chamber 164 (FIG. 4) is generally L-shaped. However, this shape may be dependent upon the angular configuration between the primary cylinder 116 and the secondary cylinder 118. Moreover, the chamber 164 is adapted to receive pressure variations from either of the cylinders 116 and 118.

Both the primary piston 126 and the secondary piston 146 are threadably engaged respectively to the primary cylinder 116 and the secondary cylinder 118. Threads associated with these arrangements are calibrated to affect a precise volume within the cylinders 116 and 118, such that every unit change in volume is attributed to a rotation of the associated hex heads 130 and 148. In effect, changes in rotary position of the primary hex head 130 and the secondary hex head 148 are directly proportional to changes in the internal volume of the chamber 164 (FIG. 4).

The pressure gauge 120 is affixed to the cylinder base 142, as the cylinder base 142 offers communicability to the chamber 164 where the extracted sample fluid is housed. This arrangement facilitates calibration of the sample fluid's pressure variations relative to the changes made in the volume by the rotation of the hex heads 130 and 148. Consequentially, a bulk modulus may be computed as a pressure variation is sustained corresponding every unit change in the volume of the chamber 164 (FIG. 4). The pressure gauge 120 is generally an analog apparatus, used to read the fluid pressure within the chamber 164. However, a digital pressure gauge may be applied.

The open/close ball valve 122 is positioned at the cylinder base 142, between the primary cylinder 116 and the quick-disconnect coupler 108. The open/close ball valve 122 may be adapted to be manually operated and to isolate the sample fluid within the chamber 164 from ambient 166. In an embodiment, the open/close ball valve 122 may be supplemented with a generally unidirectional valve 158 (FIG. 4). The unidirectional valve 158 (FIG. 4) may be positioned upstream to the open/close ball valve 122. The unidirectional valve 158 is integrated with the quick-disconnect coupler 108 to prevent leakage once the quick-disconnect coupler 108 is removed from the counter-mating coupler 112 of the test line 106.

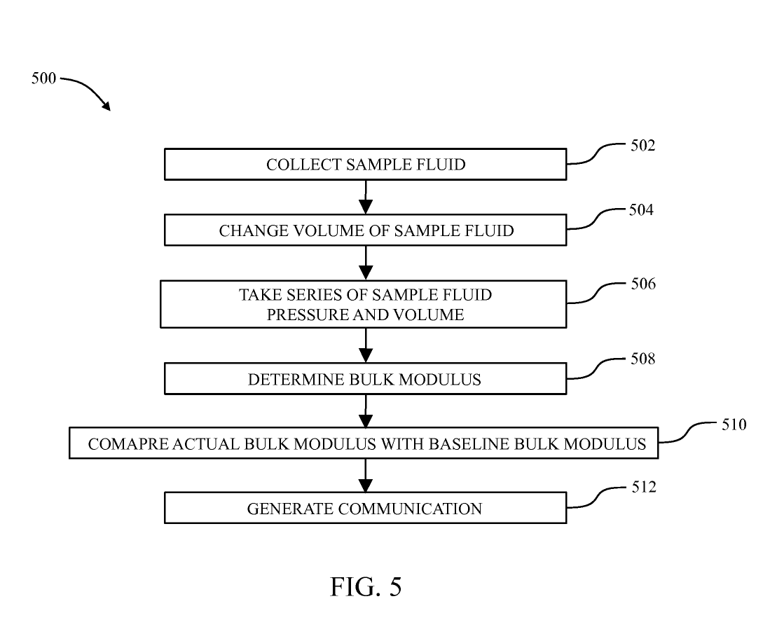

Referring to FIG. 5, an exemplary methodology of the bulk modulus apparatus 110 is explained by means of a flowchart 500. The method begins at step 502.

At step 502, an operator 114 collects a sample fluid from the hydraulic circuit 102 (closed system). To comply with the original pressure conditions of the hydraulic circuit 102, the chamber 164 maintains the collected sample fluid at a pressure equivalent to the pressure of the hydraulic circuit 102, after the sample fluid is isolated and the bulk modulus apparatus 110 is dislodged from the test line 106. The method proceeds to step 504.

At step 504, the operator 114 varies a volume of the sample fluid in the chamber 164 to generate a change in the sample fluid pressure. This change is attained by incrementally varying the volume of the primary cylinder 116, and varying a volume of the chamber 164 in finer incremental steps by the secondary cylinder 118. The incremental variation of the primary cylinder 116 is to attain larger degrees of volume variation in the chamber 164, while incremental variation of the secondary cylinder 118 may be attuned for correction of the volume of the chamber 164. Effectively, the finer incremental steps are generally minimalistic in nature so as to attain a closer to a precise volume of the chamber 164. The method proceeds to step 506.

At step 506, as each incremental variation of the volume of the cylinders 116 and 118 directly and proportionally affects a pressure of the housed sample fluid, multiple readings that pertains to change in pressure versus change in volume is noted. To this end, the operator 114 takes and records data that corresponds to a series of sample fluid pressure and sample fluid volume of the sample fluid. The method proceeds to step 508.

At step 508, since a change in pressure is obtained corresponding to the variation of volume of the sample fluid, the operator 114 determines a bulk modulus of the sample fluid. Moreover, the operator 114 at this stage is able to generate a compressibility curve for the sample fluid. The method proceeds to step 510.

At step 510, the operator 114 compares the bulk modulus of the sample fluid with a baseline bulk modulus. This stage also allows the operator 114 to ascertain an actual bulk modulus of the sample fluid. This assists in a determination of a health of the sample fluid and a level of degradation sustained by the sample fluid. A compressibility of the sample fluid is determined. As the sample fluid mimics a condition of the hydraulic fluid that runs within the hydraulic circuit 102, a state of the hydraulic fluid is determined. The method proceeds to end step 512.

At end step 512, the operator 114 generates a communication in response to the difference determined between the baseline bulk modulus and the bulk modulus of the sample fluid. More particularly, the communication is generated if the bulk modulus of the sample fluid is outside a tolerance. Thereafter, preventive maintenance strategies are initiated and a predictive strategy to prevent downtime of the power system 100 is effectively calibrated. The method ends at end step 512.

### INDUSTRIAL APPLICABILITY

In operation, an operator 114 connects the bulk modulus apparatus 110 to the test line 106. This connection is facilitated through a connection between the quick-disconnect coupler 108 and the counter-mating coupler 112. Since the quick-disconnect coupler 108 is a female coupler, the counter-mating coupler 112 (which may be a male coupler) is inserted and press fitted or threadably fitted into the quick-disconnect coupler 108. At this stage, the chamber 164 will have a minimal volume. Once the bulk modulus apparatus 110 is positively connected to the test line 106, an operator 114 opens the open/close ball valve 122 and rotates the primary hex head 130 until a certain volume of sample fluid is obtained by suction into the chamber 164. If the requirement is to have a precise volume of sample fluid, the operator 114 may operate the secondary hex head 148 to extract the finer volume of the sample fluid. At this stage, the hydraulic fluid (or the collected sample fluid) may be cycled in and out of the bulk modulus apparatus 110 to eliminate any trapped air before taking a sample fluid. Once a sample fluid is collected in the bulk modulus apparatus 110, an operator closes the open/close ball valve 122 to facilitate isolation of the sample fluid. In that manner, the bulk modulus apparatus 110 is able to maintain the sample fluid at a pressure equivalent to the original hydraulic circuit pressure. As a result, the test line connection facilitates the acquisition of a sample fluid into the bulk modulus apparatus 110. After a sufficient quantity of sample fluid is acquired into the chamber 164, the operator 114 closes the open/close ball valve 122 and disconnects the bulk modulus apparatus 110 from the test line 106.

Thereafter, the operator 114 may incrementally vary a volume of the primary cylinder 116 by manipulating the primary hex head 130 of the primary cylinder 116. This causes the primary piston 126 to move along the longitudinal axis 150 of the primary cylinder 116 and compresses the sample fluid acquired within the chamber 164. Similarly, the operator 114 may adjust the secondary hex head 148 to vary and correct finer volumes of the sample fluid. Since change in volume leads to a change in pressure of the sample fluid, pressure readings are recorded for several different instances of volumes. As a result, the operator 114 calculates a bulk modulus of the sample fluid. As multiple readings are recorded for different volumes, multiple values of bulk modules are obtained. An operator 114 plots these values graphically and computes a compressibility curve of the sample fluid. The operator 114 then compares this compressibility curve, also referred to as an actual bulk modulus, to a baseline bulk modulus. Subsequently, the operator 114 generates a communication if the bulk modulus of the sample fluid breaches a tolerance. Additionally, by usage of the compressibility curves, the gaseous content in the sample fluid that may factor in the reproduction of the characteristic compressibility curve, are also determined.

If such a communication is generated, it may be imperative for authorized personnel to initiate precautionary measures and preventive actions. As an example, precautionary measures may include change of the components and a change in the hydraulic fluid as one analyzes the degradation that the fluid has sustained along a prolonged operational period.

If an initial stage failure is predicted or sensed prior to an imminent catastrophic failure, a deteriorated component may be replaced or repaired before damage to other components occurs. Additionally, it may also signal a change of fluid well before downtime affects a machine. Moreover, if imminent failure of a component is detected, preventive maintenance strategies on the component could be scheduled at the most opportune time to reduce productivity losses typically caused by such a maintenance operations.

Advantageously, the portability of the bulk modulus apparatus 110 and provision of a standardized counter-mating coupler 112 on the bulk modulus apparatus 110 allows the bulk modulus apparatus 110 to be applicable on various other ports of the power system 100 that apply hydraulic power. Moreover, the counter-mating coupler 112 allows for relatively easy installation and removal of the bulk modulus apparatus 110 from the test line 106 of the hydraulic circuit 102. Therefore, the bulk modulus apparatus 110 may be applied to machines and systems even outside the power system 100.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method to analyze fluid degradation in a closed system, the method comprising:
collecting a sample fluid from the closed system, the sample fluid being maintained at a sample fluid pressure, the sample fluid pressure being substantially equivalent to a pressure of the closed system;
changing a volume of the sample fluid to generate a change in the sample fluid pressure;
taking a series of sample fluid pressure and sample fluid volume of the sample fluid;
determining a bulk modulus of the sample fluid;
comparing the bulk modulus of the sample fluid with a baseline bulk modulus; and
generating a communication in response to the bulk modulus of the sample fluid being outside a tolerance.
